(19) United States
(12) Patent Application Publication
(10) Pub. No.: US 2011/0081630 A1
(43) Pub. Date: Apr. 7, 2011

(54) DENTAL VENEER SYSTEM AND METHOD

(76) Inventor: Stephen L. Beveridge, Los Gatos, CA (US)

(21) Appl. No.: 12/896,239

(22) Filed: Oct. 1, 2010

Related U.S. Application Data
(60) Provisional application No. 61/247,709, filed on Oct. 1, 2009.

(51) Int. Cl. A61C 5/00

(52) U.S. Cl. 433/217.1

(57) ABSTRACT

A system and method of manufacturing prefabricated dental veneers in a variety of sizes, shapes, and colors for a more economically feasible application of high-quality dental veneers, and a related process for selecting an appropriate veneer for a particular patient's tooth or teeth for application on the same day as the initial meeting. The system includes a storage kit which stores a variety of prefabricated veneers in different sizes, shapes, and colors. The kit can be refilled by ordering another set of prefabricated veneers when a particular set of a particular size, shape, or color is affixed to a patient's teeth. The kit also includes refining tools which allow for a degree of customization in the particular prefabricated veneer chosen for a particular patient.

### CROSS-REFERENCE TO RELATED APPLICATION

This application claims priority in U.S. Provisional Patent Application No. 61/247,709 filed Oct. 1, 2009, which is incorporated herein by reference.

### BACKGROUND OF THE INVENTION

1. Field of the Invention

The present disclosed technology relates generally to dentistry, and in particular to a dental veneer system and method.

2. Description of the Related Art

Various dental procedures and prosthetics are used to improve the aesthetics of teeth by either covering damaged tooth structure or replacing missing tooth structure. Dental veneers are a type of dental appliance consisting of a thin layer of dental restorative material such as porcelain or a dental composite resin that is colored and shaded to match the appearance of a dental patient's existing teeth. The veneer is either placed on the buccal or outer surface of a tooth and bonded thereto, or built up in layers on the tooth structure. The underlying tooth is usually prepared to receive the veneer by removal of a minimal amount of tooth enamel. Resin cement is used to affix the veneer to the outside of the tooth. Porcelain veneers are durable and very aesthetic but must be manufactured in a dental laboratory. Composite veneers can be created in a dental laboratory, incurring a laboratory fabrication fee. They can also be fabricated in the mouth of a patient in the clinical setting reducing the chair time and costs.

The current practice of dental veneer manufacture and application is fraught with great expense and unnecessary complications. Because porcelain veneers cannot be created in the clinical setting in most situations, the appliance must be manufactured off-site at great expense to the patient. Patients typically need to visit the dental office at least three separate times: the initial examination to determine the size, shape, and color of the porcelain veneers; a subsequent office visit for preparation of the patient's teeth; and a third visit for placement of the porcelain veneers. Problems with porcelain veneers occur when they become damaged. A damaged porcelain veneer cannot be repaired; it must be completely remade in the lab at great cost and subsequently substituted for the damaged tooth in the clinical setting. Laboratory processed composite veneers would also require multiple patient visits to the dental office because they are made from impressions of the patient's teeth and are fabricated in the dental lab. Composite veneers created in the clinical setting begin as a composite dental resin in the form of a gel or paste that is placed by the dentist on the prepared tooth of the patient. The composite is built up in layers that are light-cured or self-cured in the patient's mouth. However, voids and cracks can be cured into the composite during the incremental layering process, requiring a great deal of surface polishing of the veneer during application to attain an aesthetic finish.

What is needed is a system and method of dental veneer selection, production, and application that can be accomplished in one dental office visit that produces an aesthetic smile at a relatively low cost. Heretofore there has not been available a dental veneer system and method with the advantages and features of the disclosed subject matter.

### BRIEF SUMMARY OF THE INVENTION

Disclosed herein in an exemplary embodiment is a system and method of manufacturing, storing, selecting, and applying dental veneers of a plurality of standard shapes, sizes, and shades. Such a system offers an economically feasible alternative to the standard, more expensive practice of custom-manufacturing dental veneers in a laboratory. With the present invention, a patient's tooth size, shape, and shade can be selected by a dental professional and the appropriate veneer can be selected from a kit and applied to the patient's tooth during the initial visit, rather than spending time having the veneer crafted in a laboratory in another location.

The preferred embodiment of the present invention includes a dental veneer kit comprising a storage container, a veneer tray, refining tools, and a plurality of prefabricated dental veneers. Said veneers come in a limited but wide variety of shapes, sizes, and colors. This allows for a best-fit option that closely matches a patient's tooth to be chosen, the prefabricated veneer selected, and the veneer applied to the patient's tooth, all in the initial meeting between the dental professional and the patient. This process allows the dental professional to charge a fraction of the cost of a custom-made veneer that is the industry standard, while maintaining maximum quality of said veneers. Said refining tools allow the dental professional to somewhat customize the prefabricated veneer on the spot while applying said veneer to the patient's tooth.

The dental professional and patient undergo a simple process to select the appropriate veneer. During a patient exam, the desire to have high-quality veneers applied to the patient's teeth may arise. The dental professional identifies target teeth, chooses an appropriate prefabricated veneer, checks it for fit, and permanently affixes it to the tooth, all in the initial patient-professional meeting period.

### BRIEF DESCRIPTION OF THE DRAWINGS

The drawings constitute a part of this specification and include exemplary embodiments of the disclosed subject matter illustrating various objects and features thereof, wherein like references are generally numbered alike in the several views.

FIG. 1 is a front view of a dental patient's mouth displaying both upper and lower teeth.

FIG. 2 is a front view of the top teeth of a patient's mouth, showing the application of a prefabricated veneer onto the teeth, embodying the principles of the disclosed subject matter.

FIG. 3 is an isometric view generally of an example of a prefabricated veneer kit, including veneer tray and abrasive tools.

FIG. 4 is a flow chart of the process used to select and apply prefabricated veneers to a patient's teeth.

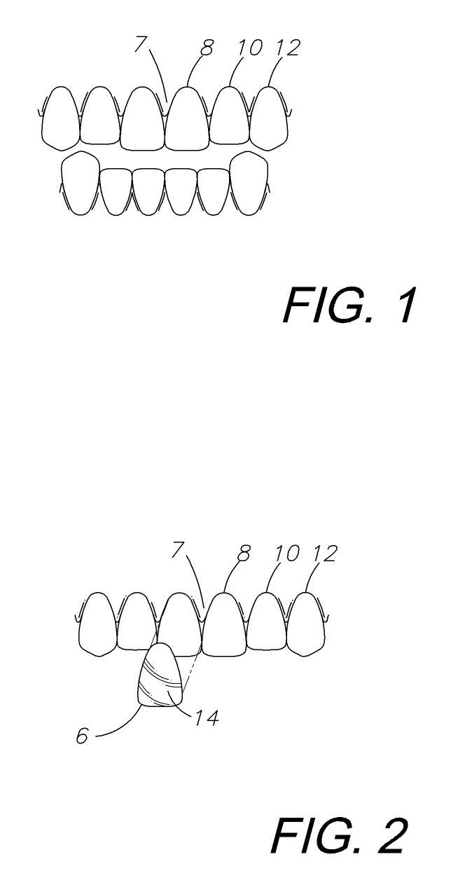

### DETAILED DESCRIPTION OF THE PREFERRED EMBODIMENT

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Said terminology will include the words specifically mentioned, derivatives thereof and words of similar meaning.

### II. Embodiment or Aspect of the Dental Veneer System 2

Referring to the drawings in more detail, the reference numeral 2 generally designates a prefabricated dental veneer system and method embodying the principles of the disclosed subject matter. The veneer system 2 consists of a veneer kit 4 containing prefabricated dental veneers 6 dimensioned to fit on the buccal surface of the six anterior teeth of the maxilla and mandible (i.e., the left and right central incisor 8, lateral incisor 10, and canine 12) in the four most common sizes of adult teeth. Alternatively, the veneer system 2 can include veneers 6 for the other teeth such as the first and second premolars, and first and second molars. The veneers 6 are manufactured from rigid dental restorative materials well known in the dental art such as dental composite resins or porcelain. The buccal surface 14 of the veneer 6 is polished providing a pre-finished appearance. The veneers 6 also contain shading, preferably shading approximating the four most common intrinsic shades of teeth. The veneer kit 4 can be enlarged to include more shades and sizes as needed in the dental profession. Alternatively, the veneers 6 can be provided in a neutral color, and shading can be applied using shading materials available in the dental office.

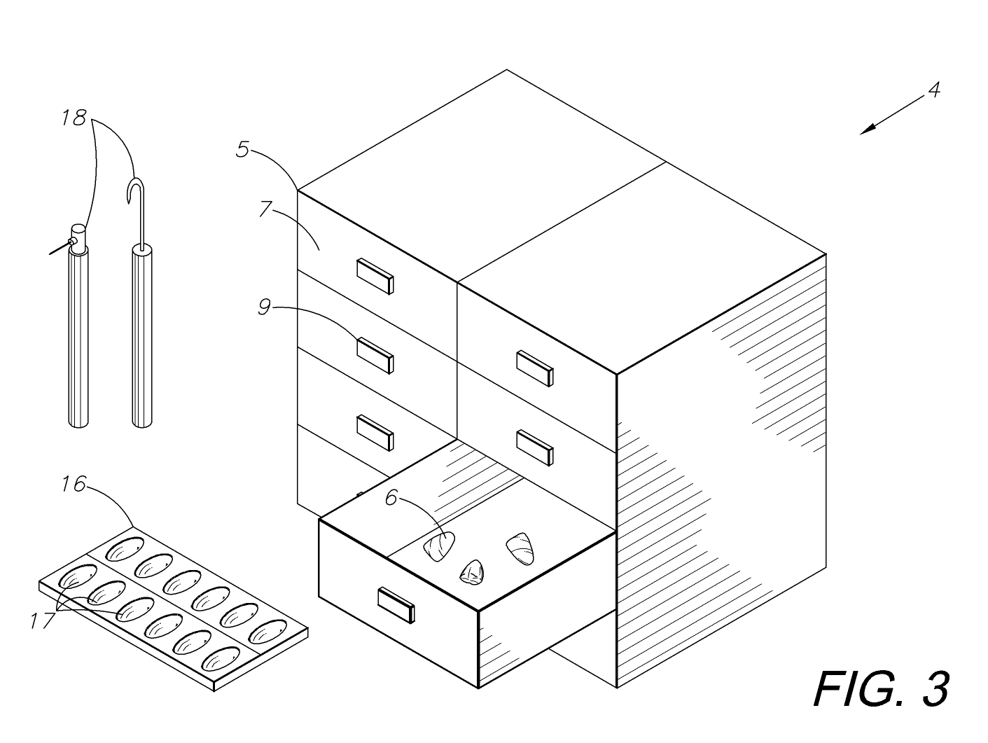

FIG. 3 shows an example of a prefabricated veneer kit 4, including veneer tray 16 and abrasive refining tools 18. The veneer kit 4 is located in the dental office and can accommodate the vast majority of patients needing dental veneers enabling the dentist to select and apply dental veneers 6 in the clinical setting in a single patient visit. The veneer kit 4 includes a storage unit 5 comprised of several compartments 7. The compartments 7 allow for easy divided storage of the variety of veneers and tools associated with the kit 4. Each compartment 7 may be identified via an identification sticker 9 or other identification method on the front of each compartment. In a preferred embodiment, the storage unit 5 is a multi-compartment container that may stand upright or be laid down. Each compartment 5 may or may not be opened individually.

Each veneer kit 4 will have several hundred veneers 6, and provide variations for each tooth type, size, and shade. The kit 4 will also include a veneer tray 16. The tray 16 includes dividers 17 numbered according to the corresponding tooth, which allows the dentist to select and layout the appropriate veneers for application on the patient in an organized manner. Each divider 17 is a recessed portion of the tray which allows veneers to be temporarily stored and easily recovered by the dental professional during the procedure.

As the veneers 6 in the veneer kit 4 are used up the dentist can replenish the veneer 6 supply by ordering the necessary veneer type, dimension, size, and shade. The dentist can order replacement veneers one or two at a time to keep his costs down and keep the kit 4 complete for the next patient. By having an assortment of veneers for different teeth, different teeth shades, and different teeth sizes, the veneer kit 4 eliminates the delay and expense of off-site manufacture of veneers. It should be noted that the example in FIG. 3 is merely an example of such a veneer kit 4, and does not limit the inclusion of other instruments in the kit or limit the design of said kit.

### III. Dental Veneer 6 Selection and Application

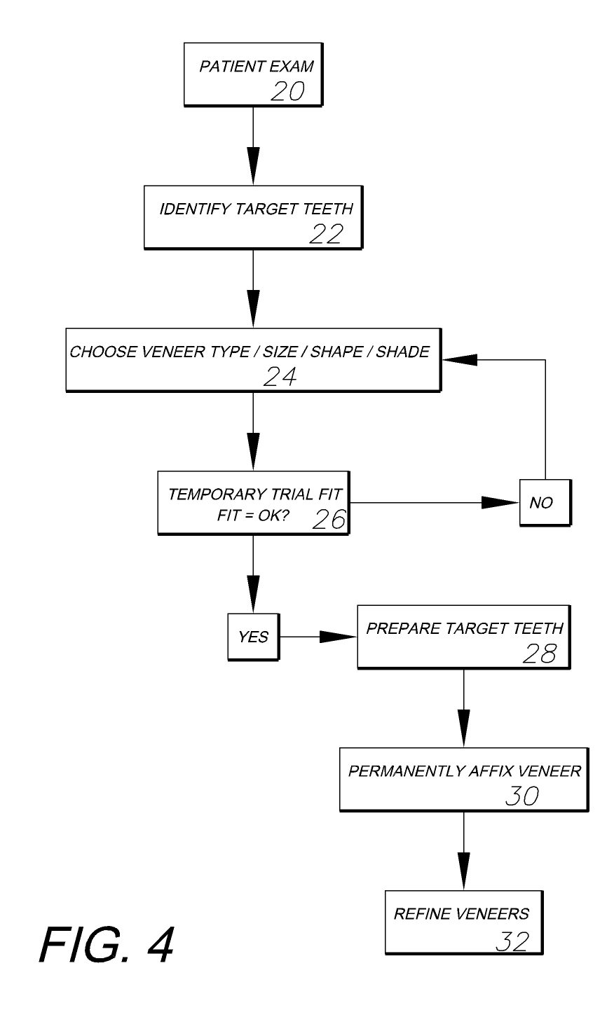

FIG. 4 illustrates a flowchart for the veneer 6 selection and application procedure.

First a dental patient examination 20 is conducted by a dentist and the teeth selected for receiving a dental veneer 6 are identified 22. The patient and doctor determine the type 24 of veneer desired, either porcelain or composite, and select the desired size of the veneer and shade. The dentist then temporarily affixes the veneers 26 to their target teeth with try-in paste. The temporarily-applied veneers 6 are checked to ensure the desired aesthetics are achieved such as tooth dimension, size, and shade. If the fit is not proper, a new selection of veneers is made. Once a satisfactory set of veneers has been selected, the dentist prepares the target teeth for permanently receiving the veneers 28 by cleaning and acid etching the tooth enamel on the buccal surface 14. Anesthesia is generally not necessary for the patient unless the target teeth require a substantial reduction in size or reshaping. The dentist then applies resin cement to the target tooth and permanently affixes the corresponding veneer 30 to the tooth. The veneer and bonding resin cement are then cured a first time. The dentist may then make adjustments to the veneer 6 and refine the dimensions of the veneer 32 by cleaning the edges with abrasive tools 18. The resin cement is then cured completely and the dentist can further refine the aesthetics of the veneer 6 by using composite and porcelain trimming burs and hand instruments to fine-tune the finish lines with the teeth and gum tissues 7. Finally, the dentist can then adjust the esthetics and smile line.

It will be appreciated that the components of the prefabricated veneer system 2 can be used for various other applications. Moreover, prefabricated veneers 6 can be fabricated in various sizes and from a wide range of suitable materials, using various manufacturing and fabrication techniques.

It is to be understood that while certain aspects of the disclosed subject matter have been shown and described, the disclosed subject matter is not limited thereto and encompasses various other embodiments and aspects.

Having thus described the disclosed subject matter, what is claimed as new and desired to be secured by Letters Patent is:

1. A system for the application of prefabricated veneers for human teeth, comprising:
a plurality of prefabricated veneers;
a storage unit for the storing of said prefabricated veneers to aid in organization and correct selection; and
a veneer tray adapted for the temporary storage of said veneers;
abrasive dental tools adapted for refining and smoothing the surface of said veneers;
said prefabricated veneers adapted to fit the general shape of average patient teeth; wherein the application of said prefabricated veneers performed in one visit from a patient.

2. The system according to claim 1, including:
said prefabricated veneers being made of porcelain or other common veneer-manufacturing materials.

3. The system according to claim 2, wherein said prefabricated veneers are comprised of a variety of shapes, sizes, and colors.

4. The system according to claim 3, wherein said prefabricated veneers are selected for a patient to match the patient's natural tooth shape, size, and color.

5. The system according to claim 1, including:
said storage unit comprising a cabinet including a plurality of compartments; and
said drawers adapted for receiving labels identifying the contents of said compartment.

6. The system according to claim 1, including:
said veneer tray comprising a suitably flat tray manufactured from sterile material;
said tray including a plurality of smooth recesses, the recesses adapted for temporarily receiving and storing the veneers selected for application to the patient's teeth; and
wherein the recesses are numbered to conform with the standard number of teeth in a patient's mouth.

7. The system according to claim 1, including:
the inspection of said patient's teeth for appropriate size, shape, and color and to determine the target teeth for veneers;
the selection of an appropriate prefabricated veneer from said veneer kit;
the trial of said selected prefabricated veneer for appropriate fit;
the permanent affixation of said selected prefabricated veneer on said patient's targeted tooth; and
the quick replacement within the veneer kit of the used selected veneers by ordering that particular model from the manufacturer.

8. A method for permanently correcting a patient's teeth through the application of prefabricated veneers, the method comprising the steps:
manufacturing prefabricated veneers in a plurality of common sizes, shapes, and shades for the permanent affixing to human teeth;
ordering a set of said veneers for use in general dentistry practice;
providing a storage unit of said prefabricated veneers, consisting of separators for organizing and selecting those veneers of particular shapes, sizes, and shades;
providing a plurality of abrasive dental tools adapted for refining the surface of said veneers;
inspecting a patient's teeth to determine target teeth for veneer application, including the shape, shade, and size of those teeth;
selecting the appropriate prefabricated veneer from said kit and applying it to said patient's targeted teeth;
determining whether the selected veneer fits appropriately;
permanently affixing said veneer to said targeted teeth;
refining the affixed veneers using said abrasive tools to ensure a proper and comfortable fit;
reordering replacement prefabricated veneers for said veneer storage unit; and
performing the entire procedure during a single patient visit.

9. A system for the application of prefabricated veneers for human teeth, comprising:
a plurality of prefabricated veneers, said veneers being made of porcelain or other common veneer-manufacturing materials of a variety of shapes, sizes, and colors;
said veneers being adapted for selection to match a patient's natural tooth shape, size, and color;
a storage unit for the storing of said prefabricated veneers to aid in organization and correct selection, said storage unit comprising a cabinet including a plurality of compartments;
said drawers adapted for receiving labels identifying the contents of said compartment;
a veneer tray comprising a suitably flat tray manufactured from sterile material, said tray including a plurality of smooth recesses adapted for temporarily receiving and storing the veneers selected for application to the patient's teeth;
said veneer tray recesses being numbered to conform with the standard number of teeth in a patient's mouth; and
abrasive dental tools adapted for refining and smoothing the surface of said veneers;
said prefabricated veneers adapted to fit the general shape of average patient teeth; wherein the application of said prefabricated veneers performed in one visit from a patient.
